(19) United States
(12) Patent Application Publication
(10) Pub. No.: US 2002/0169843 A1
(43) Pub. Date: Nov. 14, 2002

(54) Data managing apparatus for analytical device

(75) Inventor: Shinya Tsuneda, Kyoto-shi (JP)

Correspondence Address: KANESAKA AND TAKEUCHI, 1423 Powhatan Street, Alexandria, VA, 22314, US

(73) Assignee: SHIMADZU CORPORATION

(21) Appl. No.: 10/124,308

(22) Filed: Apr. 18, 2002

(30) Foreign Application Priority Data
May 11, 2001 (JP) 2001-141023

(51) Int. Cl. G06F 15/16

(52) U.S. Cl. 709/206; 709/229

(57) ABSTRACT

In a data managing apparatus for an analytical device, when data managing software starts up, a log in dialog box is displayed, and an operator inputs ID and password of the access. In case the input ID and password do not match the registered ones, the ID and password are prompted again. When unsuccessful access is repeated for predetermined times, a preset electronic mail is sent to a registered address, and start-up command reception thereafter is prohibited. Since an administrator can take a proper response upon receiving the electronic mail right after the unauthorized access occurred, it is possible to maintain strict security, such that the administrator can identify an operator who tried the unauthorized access.

### BACKGROUND OF THE INVENTION AND RELATED ART STATEMENT

The present invention relates to a data managing apparatus for an analytical device using a computer, such as a personal computer. More specifically, the data managing apparatus for the analytical device of the present invention is provided with an unauthorized use prevention function for preventing an unauthorized user from accessing, using and altering data.

Recently, in order to secure reliability of data management in a field of food inspection or new medical product development, guidelines called “Good Laboratory Practice” (GLP) or “Good Manufacturing Practice” (GMP) have been implemented. GLP and GMP include strict standards in setting conditions for tests and inspections as well as management of data including the test results. Thus, it is required to have countermeasures for preventing data from being altered or erased inadvertently or intentionally. As one of the countermeasures, in a conventional analytical device, security controls are provided at various levels. For example, alterations and deletions of data can not be made by an operator other than a specific person who has a permission to do such operations beforehand (hereinafter referred to as an “administrator”).

One way of improving the security is an authentication process that requires a password to log in for starting up an operating system (OS) or specific application software. According to this method, unless a password only a user with permission knows is input, a computer will not operate or a desired function can not be used, so high security is maintained.

Generally, in the log in dialog for authentication of a password, if an operator inputs a wrong user name or password, the wrong input is notified and, at the same time, a message for prompting a correct input is displayed. When the wrong input is repeated several times, further input is prohibited for a predetermined period of time, or the user name becomes void.

However, in the conventional method as described above, although an unauthorized access itself can be prevented, an administrator will not notice the unauthorized access until an access log is confirmed. Therefore, it is difficult to identify a person who attempted such an unauthorized access, and in addition, a quick response to the unauthorized access tends to be difficult.

In view of the above problems, the present invention has been made and an object of the present invention is to provide a data managing apparatus for analytical devices, wherein high security can be obtained against an unauthorized access and, especially, a quick response can be taken against such an unauthorized access.

Further objects and advantages of the invention will be apparent from the following description of the invention.

### SUMMARY OF THE INVENTION

In order to solve the above problems, in the present invention, a data managing apparatus for an analytical device, which is connected to a network and has a data managing function for managing data obtained at the analytical device as a database and a file, includes: authentication means for requesting an input of authentic information with respect to a person who tries to use the data managing function; reference means for comparing the input authentic information to a registered authentic information; electronic mail registration means for registering an electronic mail address in advance; and electronic mail sending means for sending an electronic mail to the address registered in the electronic mail registration means in case the input authentic information does not match the registered authentic information repeatedly for predetermined times.

The data managing apparatus further includes usage prohibition means for prohibiting use of at least the data managing function for a predetermined time when the approval information does not correspond to the registered one repeatedly for predetermined times.

According to the data managing apparatus for analytical devices of the present invention, if an operator who does not have proper authentic information, i.e. authorized ID and password, tries to use the data managing function, at the time the unauthorized approval information is input repeatedly, i.e. predetermined times, the electronic mail sending means sends an electronic mail to the registered address. Therefore, an administrator who received the electronic mail can notice that an unauthorized access is made to thereby immediately take a proper action for identifying the unauthorized user. Thus, it is possible to maintain higher security than simply rejecting the unauthorized access.

### BRIEF DESCRIPTION OF THE DRAWINGS

FIG. 1 is an explanatory diagram for showing an entire structure of an example of a data managing system for analytical devices including a data managing apparatus for the analytical devices according to the present invention;

FIG. 2 is a block diagram showing a functional structure of the data managing apparatus according to the present embodiment;

FIG. 3 is a control flow chart when the data managing apparatus of the present embodiment is used;

FIG. 4 is a drawing showing a dialog box for setting an unauthorized access notice address in the data managing apparatus of the present embodiment; and

FIG. 5 is an example showing a log in the dialog box in the data managing apparatus of the present embodiment.

### DETAILED DESCRIPTION OF PREFERRED EMBODIMENT

Hereunder, a data managing apparatus for analytical devices as an embodiment according to the present invention will be described with reference to the accompanying drawings.

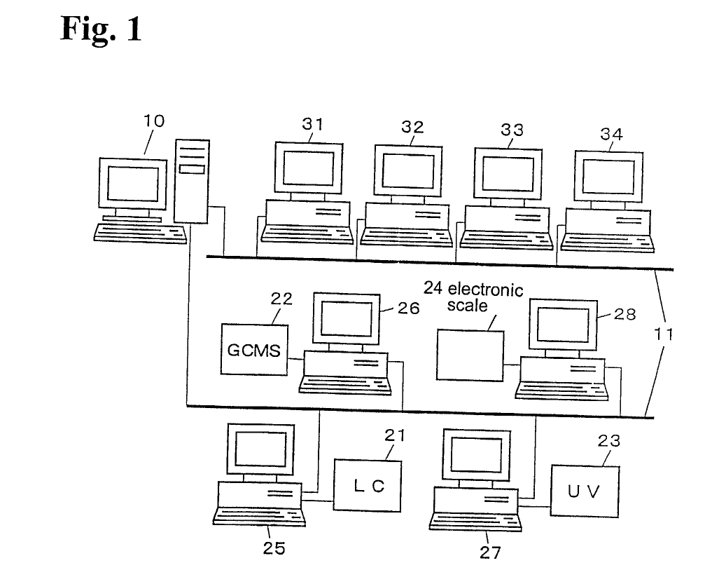

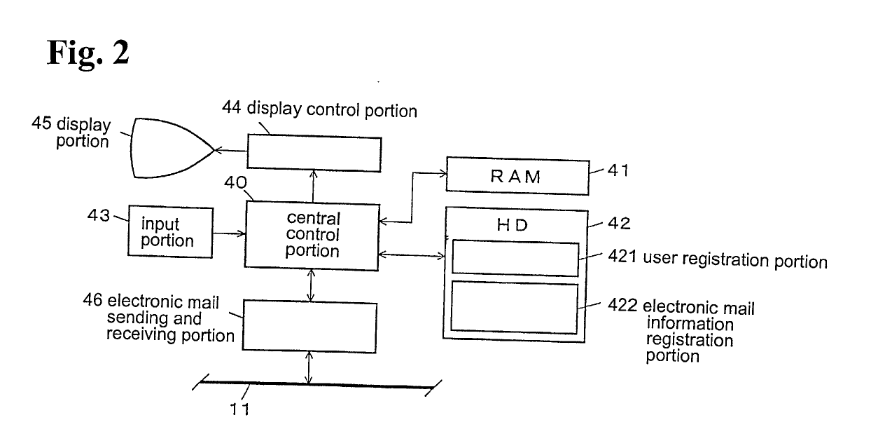

FIG. 1 is a diagram showing an entire structure of an example of a data managing system for analytical devices, utilizing a network, including a data managing apparatus for analytical devices according to the present invention. FIG. 2 is a block diagram showing a functional structure of the data managing apparatus for the analytical devices according to the embodiment.

The data managing system of the embodiment is composed of a server 10 as a central server and a client system. In the data managing system, although analytical devices 21 to 24 represent a liquid chromatography (LC), a gas chromatograph mass spectrometer (GC/MS), an ultraviolet and visible light spectrophotometer (UV) and an electronic scale, respectively, they are not limited thereto. The analytical devices 21 to 24 are provided with computers 25 to 28 for data processing, and the computers 25 to 28 are connected to a network line 11, such as an intra network, as clients. Further, independent computers 31 to 34 not directly connected to the analytical instruments are connected to the network line 11 as clients as well. Incidentally, the structure of the system shown in the drawing is just one example, and types and the number of analytical devices and the number of computers can be changed as needed.

Analytical data obtained by the respective analytical devices are collected in the server 10 as database so that a file of the data can be shared. When a client uses the database, it is necessary to install data managing software on its computer, so that various processes can be carried out in addition to retrieving and writing the file in the database on the data managing software. It is obvious that the same operations can be carried out on the server 10.

In the embodiment, the server 10 and the computers 25 to 28 and 31 to 34 as the clients constitute the data managing apparatus as shown in FIG. 2. In other words, the data managing apparatus is a group of computers equipped with the data managing software. As shown in FIG. 2, a central control portion 40 is a center of data control and processing, and is connected to RAM 41 as a temporary storing device and a hard disc drive (HD) 42 as a large capacity storing device. Also, the central control portion 40 is connected to, as an input portion 43, a keyboard and a pointing member, such as a mouse, and a display portion 45, such as CRT and a liquid crystal display, through a display control portion 44. Further, the central control portion 40 is connected to an electronic mail receiving and sending portion 46, which also has an interface function between the central control portion 40 and an outside network line 11.

The hard disc drive 42 includes a user registration portion 421 as a memory region and an electronic mail information registration portion 422. The user registration portion 421 stores user data, such as user names, IDs, passwords and access levels in advance. The access levels correspond to functions that can be used on a computer or a network system. For example, a user who has an access level as a “system administrator” can use functions relating to operation of the system. Also, a user who administers at least one computer (not the entire system) can use a notice function, which alerts when an unauthorized access is made and can not be accessed by other operators, as an “administrator”.

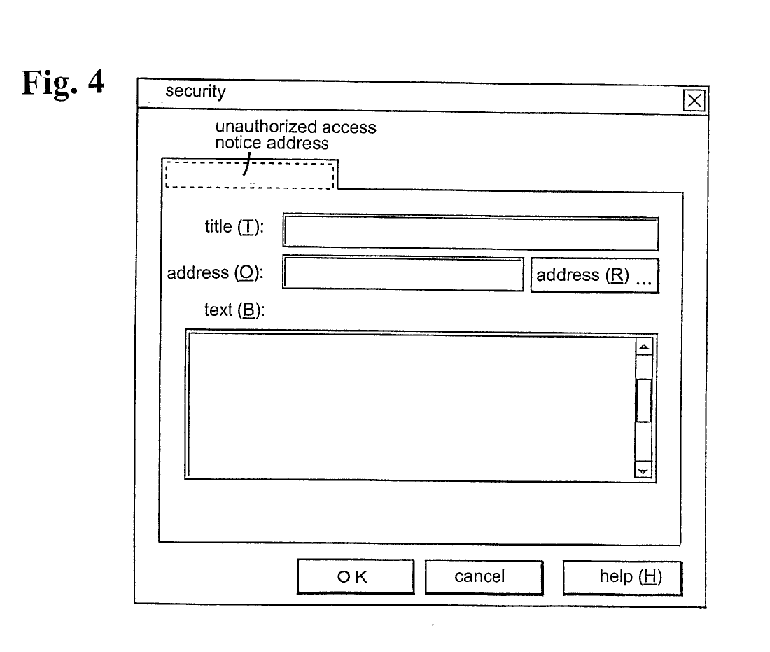

Next, how the notice function works when the unauthorized access is made will be explained in detail. In case the user uses the notice function, the user with an access level as the “administrator” has to register a message sending address and a content of the electronic mail beforehand. When the administrator carries out a specific operation at an input portion 43, the central control portion 40 responds and displays a dialog box “unauthorized access notice address” on a screen of the display portion 45, as shown in FIG. 4. In the box on the screen, the administrator inputs a title, a designated address and a text of the electronic mail to be sent when an unauthorized access is made, described later, and then clicks an “OK” button. The central control portion 40 confirms the input data at that time, and stores the data in the electronic mail information registration portion 422 of the hard disk drive 42. If the administrator manages multiple computers, it is preferable to include information (a computer serial number, location and so on) in the text of the electronic mail so that the administrator can identify the computer at which an unauthorized access is attempted.

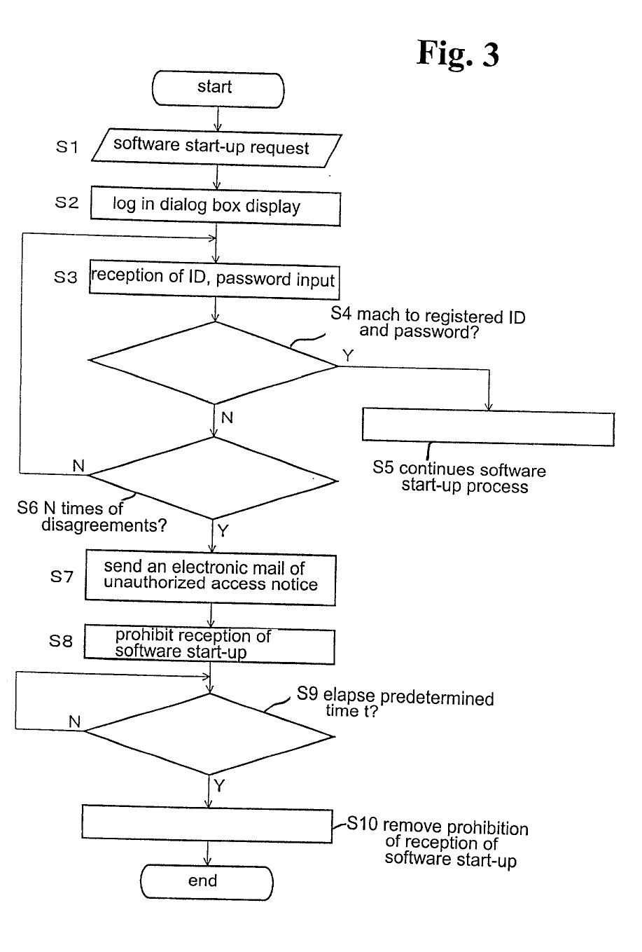

When an operator uses the data managing software with the function described above, a series of steps is carried out in accordance with the control flow chart as shown in FIG. 3.

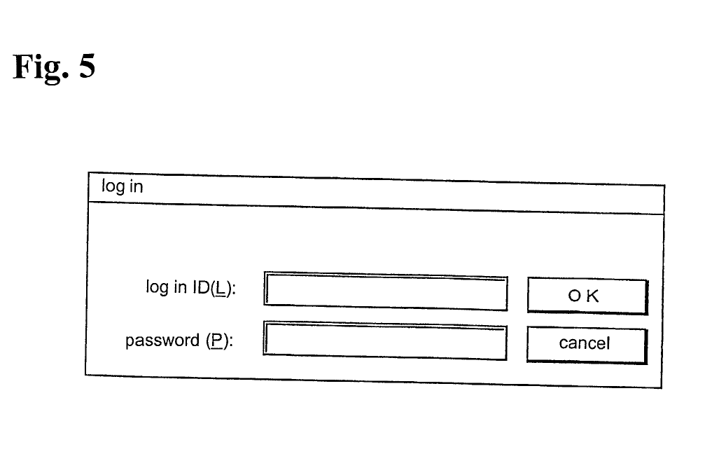

First, the operator carries out a specific operation at the input portion 43 to start up the data managing software. This operation is the same as that for starting up generic software, i.e. clicking an icon and the like (Step S1). When such an operation is carried out, the central control portion 40, first, displays a login dialog box on the screen of the display portion 45 as shown in FIG. 5 (Step S2). The operator inputs ID and password while watching the screen, and when the input information is confirmed, an “OK” button is clicked. Upon the operation, the central control portion 40 receives the ID and password (Step S3), and look up the data in the user registration portion 421 to find out the matching ID and password therein. Then, it is determined whether the input ID and password match the registered ID and password (Step S4). In case they match the registered ID and password, the operator is determined to be an authorized user, and the start-up process of the software continued (Step S5). The operator then can use functions of the software within a given access level, for example, retrieve analytical data to display or approve them.

In case the input ID and password do not match the registered ones in Step S4, for example, a specific warning sounds in order to let the operator know that the input information is incorrect (or a message such as “Please Try Again” may be displayed). This is repeated until the number of incorrect inputs reaches a certain (n) times (Step S6). Here, the system administrator can set the value of ‘n’ beforehand. Considering a possibility that a right user makes a mistake, it is generally set at n=3.

As long as the number of incorrect input is less than ‘n’ at Step S6, Step S3 is repeated and the operator can input the ID and password. When the number reaches ‘n’, it is determined that an operator who does not have a proper ID and password attempts an unauthorized access. Then, the information saved in the electronic mail information registration portion 422 is read out and transmitted to the electronic mail sending and receiving portion 46. Based on the saved information, the electronic mail is instantly sent to the unauthorized access notice addresses (Step S7). The electronic mail finally reaches the addresses through the network line 11 (or network, such as an internet). In case the network line 11 is limited to a small area, since the electronic mail itself reaches without delay, if the person who receives the electronic mail reads the message immediately, the unauthorized access can be detected immediately. Thus, a proper action can be taken quickly such as rushing to a location where the computer is installed or contacting a person in charge to investigate the computer.

Upon sending the electronic mail (Step S8), the central control portion 40 also refuses to receive a command to start up the above-described data managing software. Therefore, even if the unauthorized operator tries to start up the software again, it is no longer possible to input any ID and password for log in. Thus, the unauthorized operator can not repeat an access with a different ID and password. At this time, an operator with an authorized ID and password is also rejected to use the software since it is impossible for anyone to log in right after the unauthorized operator walks away from the computer. Thus, once a predetermined time elapses since the starting-up reception was prohibited (“Y” at Step S9), the prohibition of starting-up command reception is removed (Step S10). Incidentally, the predetermined time can be set in the order of 15 minutes during which a proper response to an unauthorized access can be taken. The system administrator can also set the time as in the same manner as in the above-stated setting ‘n’.

As described above, in the data managing apparatus of the present embodiment, since the electronic mail sending function is established beforehand to send an email upon an unauthorized access, when the unauthorized access is attempted, a specified administrator can notice immediately through the electronic mail. Thus, not only the unauthorized access can be prevented, but also an operator who tries the unauthorized access can be identified. Accordingly the data managing apparatus can effectively prevent the unauthorized access to the system.

Incidentally, the above embodiment is only an example of the present invention, and it is apparent that changes and modifications can be properly made within the scope of the present invention. For example, in the above embodiment, while the server/client type system has been described, the present invention can also be applied to a stand-alone system or a file sharing distribution system without a server.

While the invention has been explained with reference to the specific embodiments of the invention, the explanation is illustrative and the invention is limited only by the appended claims.

What is claimed is:

1. A data managing apparatus for an analytical device, comprising:
authentication means for requesting an input of authentic information with respect to an operator who tries to use the data managing apparatus;
reference means electrically connected to the authentication means for comparing the input authentic information to a registered authentic information;
electronic mail registration means electrically connected to the reference means for registering an electronic mail address in advance; and
electronic mail sending means electrically connected to the electronic mail registration means for sending an electronic mail to the address registered in the electronic mail registration means when an incorrect input of the authentic information is repeated a predetermined number of times.

2. A data managing apparatus according to claim 1, wherein said electronic mail registration means holds in advance the electronic mail to be mailed when the incorrect input is repeated.

3. A data managing apparatus according to claim 2, wherein said data managing apparatus is connected to a network.

4. A data managing apparatus according to claim 2, wherein the data managing apparatus rejects an access when the incorrect input of the authentic information is repeated a predetermined number of times.

5. A data managing apparatus according to claim 1, wherein the electronic mail sending means sends the electronic mail including an identification of a computer from which the operator tries to use the data managing apparatus.
